(19) United States
(12) Patent Application Publication
(10) Pub. No.: US 2009/0281950 A1
(43) Pub. Date: Nov. 12, 2009

(54) SYSTEM, MOBILE INFORMATION TERMINAL, EXTERNAL DEVICE, METHOD AND PROGRAM FOR EXECUTING CONTENT

(75) Inventor: Norihisa IGA, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/506,036

(22) Filed: Jul. 20, 2009

Related U.S. Application Data
(62) Division of application No. 10/786,368, filed on Feb. 26, 2004.

(30) Foreign Application Priority Data
Feb. 28, 2003 (JP) 2003-054755

(51) Int. Cl. H04L 9/00; H04M 1/00

(52) U.S. Cl. 705/59; 455/550.1; 726/26

(57) ABSTRACT

A system that executes content like music and moving pictures, and protects rights like copyright, working on a configuration of a mobile information terminal and an external device is provided. A mobile information terminal acquires a right (ticket) to execute content. An external device of higher performance, compared with a mobile information terminal, executes content after receiving the ticket from a mobile information terminal. Though content and ticket can move freely in a system, once the content is executed, an identifier for identifying the mobile information terminal that demanded the execution of content is liked with the ticket. It is this mobile information terminal that can use the same ticket again.

### CROSS REFERENCE TO RELATED APPLICATION

The present application is a Divisional of U.S. patent application Ser. No. 10/786,368, filed Feb. 26, 2004, which claims priority from Japanese Patent Application No. 2003-054755, filed on Feb. 28, 2003, which applications are incorporated herein by reference.

### BACKGROUND OF THE INVENTION

The present invention relates to a system, a mobile information terminal, an external device, method and program for executing content. In the system the mobile information terminal acquires a right of using content and the content is executed on the external device that communicates with the mobile information terminal.

### DESCRIPTION OF THE RELATED ART

Recent mobile information terminals like a cellular phone download content and execute it. However, in a view of the protection of copyright and other rights concerning to the use of content, the downloaded content is designed to stay inside a mobile information terminal and cannot be carried outside of a mobile information terminal.

To replay multimedia content, a display screen of a mobile information terminal is too small to enjoy the quality of multimedia content. At a situation in which user is outside or moving, a mobile information terminal may satisfy user's need but if there exists an external device with a higher quality than a mobile information terminal, it will give larger satisfaction to user to replay content data on the external device.

Here an “external” device means that the device exists outside of a mobile information terminal by itself.

From a provider's side, the execution of content should be restricted to those who purchased or properly acquired a ticket.

As a method of protecting copyright, a DRM (Digital Rights Management) system is well known. In the DRM system, user freely obtains content but needs a license issued from a license server to replay it. Copyright is protected in this way.

Prior documents are introduced below.

Japanese Patent Application Laid-Open No. 2001-8254 aims to improve human interface, displaying a map at a larger display than that of a cellular phone.

Even though a display device with a larger screen is used, the condition of the use of content is not considered. Further, the fact that data is accepted by a mobile information terminal from a server will cause an increase of load when content data are comparatively large or accesses are excessively concentrated.

In Japanese Patent Application Laid-Open No. 2001-285417, a mobile information terminal replays music data stored in a memory card and the replayed music data is transferred to a speaker through a connector.

Capacity of a memory card is not large enough to execute a high sound and picture quality data and the large data for a long hour replay. The data is originally designed to match with the performance of a mobile information terminal so even if the data is given to a sound player, the music is not replayed in a higher quality. Further, a mobile information terminal replays the data stored in a memory card so it cannot cope with streaming data.

In Japanese Patent Application Laid-Open No. 2002-311962, an external device, which has a smaller capacity, purchases content, downloads pictures and lyrics, and at this process reduces the information attached to the content data so that the content data are efficiently downloaded.

In this system, the external device with a small capacity cannot handle a higher sound and picture quality data.

In Japanese Patent Application Laid-Open No. 2002-297816, the number of issuance of a license is recorded and licenses are sent to others freely. In this way, content is replayed easily on any device.

In this system it is meaningless to identify the user who first purchased a license or a device that first acquired a license because those who possess a license can execute content data on any device. Further, those who possess a license can execute content data as much as the numbers of the use of content permit.

Japanese Patent Application Laid-Open No. 2001-258008 adapts the similar system and makes a limit to the numbers of the use of content.

As described above, in conventional systems there are problems that the load to a system increases, the performance of a hardware for replaying data is not brought out enough, a system does not correspond to streaming data and the one who got a license does not match with the one who commands an execution of content data.

### SUMMARY OF THE INVENTION

It is therefore an object of the present invention to provide solutions to the above-mentioned problems.

A mobile information terminal acquires a right (ticket) to execute content. An external device of higher performance, compared with a mobile information terminal, executes content after receiving the ticket from a mobile information terminal. Though content and ticket can move freely in a system, once the content is executed, an identifier for identifying the mobile information terminal that demanded the execution of content is liked with the ticket. It is this mobile information terminal that can use the same ticket again.

### BRIEF DESCRIPTION OF THE DRAWINGS

The objects and features of the present invention will become more apparent from the consideration of the following detailed description taken in conjunction with the accompanying drawings in which:

FIG. 1 is a diagram showing a system of the first embodiment;

FIG. 2 is a block diagram showing a configuration of a mobile information terminal;

FIG. 3 is a block diagram showing a configuration of an external device;

FIG. 4 is a sequence diagram showing an operation of an external device from a mobile information terminal in a first embodiment;

FIG. 5 is a sequence diagram showing a replay of content data on an external device in a first embodiment;

FIG. 6 is a sequence diagram showing an action of the system in a second embodiment;

FIG. 7 is a diagram showing a configuration of the system in a third embodiment;

FIG. 8 is a sequence diagram showing an action of the system in a third embodiment;

FIG. 9 is a diagram showing a configuration of an external device in a fourth embodiment;

FIG. 10 is a diagram showing the communication between a mobile information terminal and an external device in a fifth embodiment; and

FIG. 11 is a diagram showing a configuration of the system in a sixth embodiment.

### DESCRIPTION OF THE PREFERRED EMBODIMENT

### First Embodiment

A first embodiment shows how to replay multimedia data “content” (moving pictures, pictures, music data and so on) at a mobile terminal and an external device. Hereinafter the right to use content is called “ticket”.

<Structure of a System>

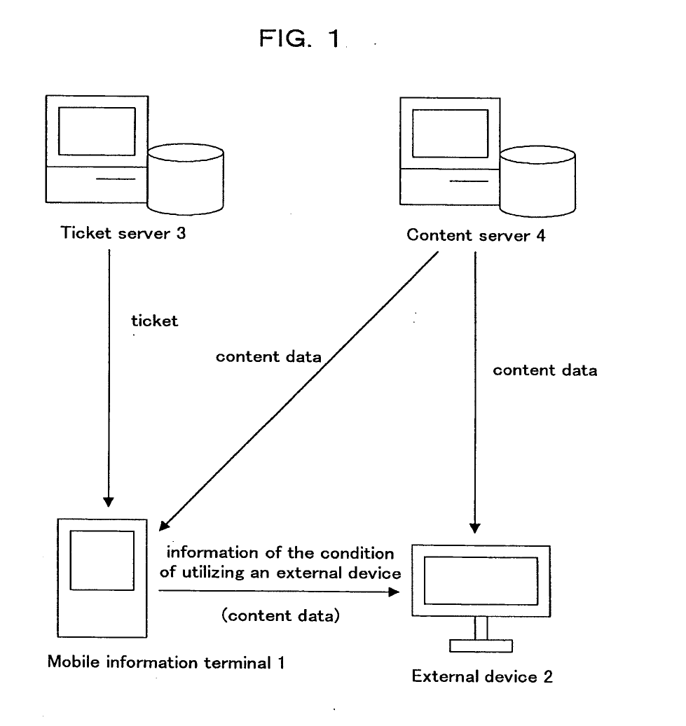

Referring to FIG. 1, a system of a first embodiment is explained.

This system comprises a mobile information terminal 1, an external device 2, a ticket server 3, and a content server 4. A ticket server 3 and a content server 4 may be put together in one device.

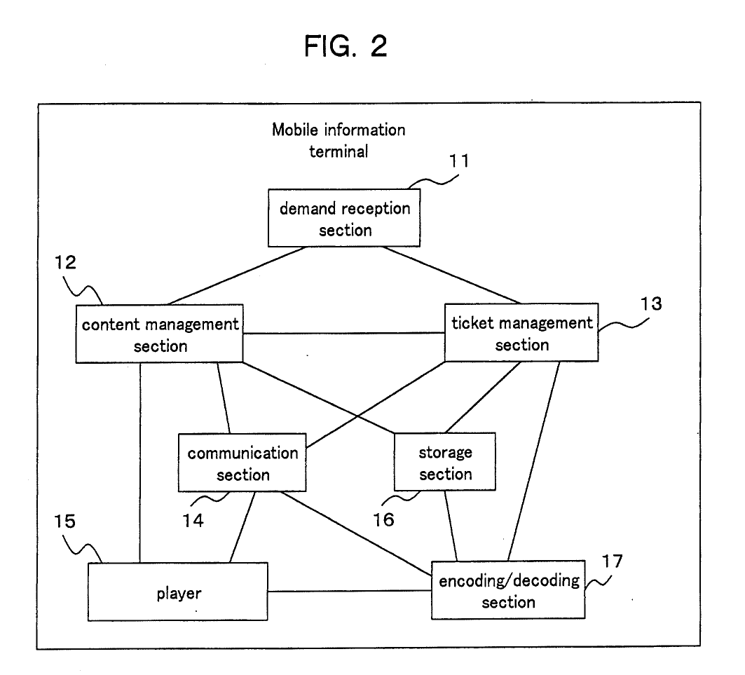

The mobile information terminal 1 manages tickets and executes content. FIG. 2 is a block diagram of the mobile information terminal 1. The detailed explanation is given later.

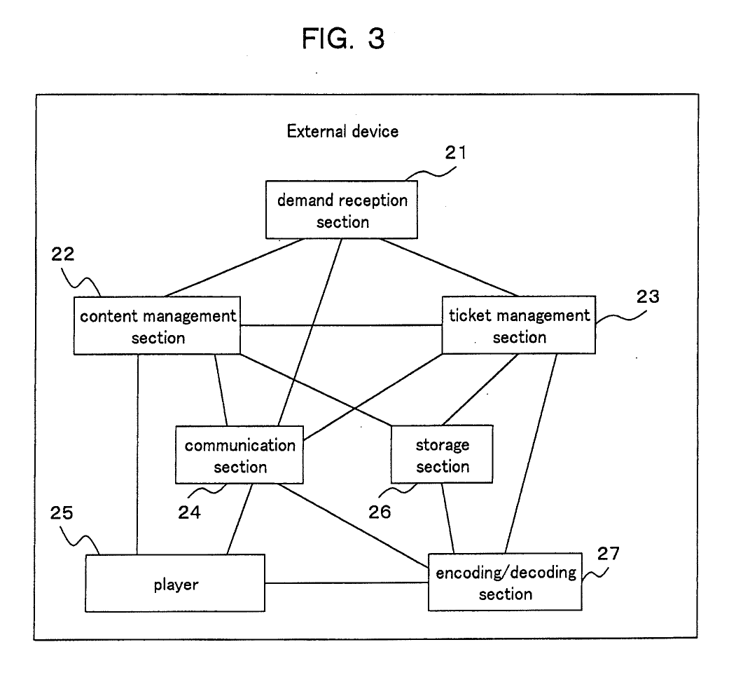

The external device 2 executes content. The external device 2 communicates with the mobile information terminal 1 wirelessly or through a cable. FIG. 3 is a block diagram of the external device 2. The detailed explanation is given later.

The ticket server 3 issues a ticket corresponding to the content that the content server 4 manages. Receiving a demand from a mobile information terminal, the ticket server 3 provides a ticket.

The ticket includes the information of the source that supplies contents and the condition of the use of content, for example, a restriction by frequency or time. The ticket server 3 is connected to the mobile information terminal 1 wirelessly or by a cable.

The content server 4 manages content data and receiving a demand from the mobile information terminal 1, supplies content data. This content data may be encoded.

The content server 4 communicates with the mobile information terminal 1 wirelessly or through a cable. The content server 4 communicates likewise with the external device 2.

<Mobile Information Terminal 1>

FIG. 2 shows the structure of the mobile information terminal 1.

The mobile information terminal 1 comprises a demand reception section 11, a content management section 12, a ticket management section 13, a communication section 14, a player 15, a storage section 16 and an encoding/decoding section 17.

Generally equipped elements of a mobile information terminal, for example, an input device (a keyboard etc.) and an output device (a display, a speaker etc.), are omitted here.

The demand reception section 11 provides user with a control screen and receives demands for a ticket, content, an execution of content etc. from the control screen or an input device.

The content management section 12 checks content data and boots a player 15.

The ticket management section 13 deals with the management of tickets.

The communication section 14 communicates with the external device 2, the ticket server 3 and the content server 4. The communication section 14 communicates wirelessly or through a cable.

The player 15 executes content data.

The storage section 16 stores content data and tickets. The storage section 16 may be realized by a removable memory card.

The encoding/decoding section 17 encodes and decodes content data and tickets. The encoding/decoding section 17 provides a secure communication.

<External Device 2>

FIG. 3 shows the structure of the external device 2.

The external device 2 comprises a demand reception section 21, a content management section 22, a ticket management section 23, a communication section 24, a player 25, a storage section 26 and an encoding/decoding section 27.

The demand reception section 21 analyzes demands from the mobile information terminal 1 and transfers the result to the content management section 22 and the ticket management section 23.

The content management section 22 checks content data and boots the player 25.

The ticket management section 23 deals with the management of tickets.

The communication section 24 communicates with the mobile information terminal 1 and the content server 4. The communication section 24 communicates wirelessly or through a cable.

The player 25 executes content data.

The storage section 26 stores content data, the conditions of the use of content and so on. The storage section 26 may be realized by storage media like a compact disc with content data written in it or a removable memory card.

The encoding/decoding section 27 encodes content data and a ticket, and decodes encoded data. The encoding/decoding section 27 provides a secure communication.

<Operation of the System>

This embodiment can be divided into the following three scenes:

(I) Preparation.

(II) Use of content at a mobile information terminal.

(III) Use of content at an external device.

These scenes are explained in detail below.

<(I) Preparation>

At the preparation, it is prepared to distribute content data. A provider of content puts content data in the content server 4. The content data are linked with content IDs. The content ID is delivered to the ticket server 3.

These information delivered to the ticket server 3 are included in a ticket as a part of ticket information when a mobile information terminal gets the ticket.

Content data may be encoded and put in the content server 4. In this case, a key for decoding the data is delivered to the ticket server 3 with a content ID.

<(II) Use of Content at a Mobile Information Terminal>

Here is described an outline of the process in which a user enjoys content without an external device near him or her.

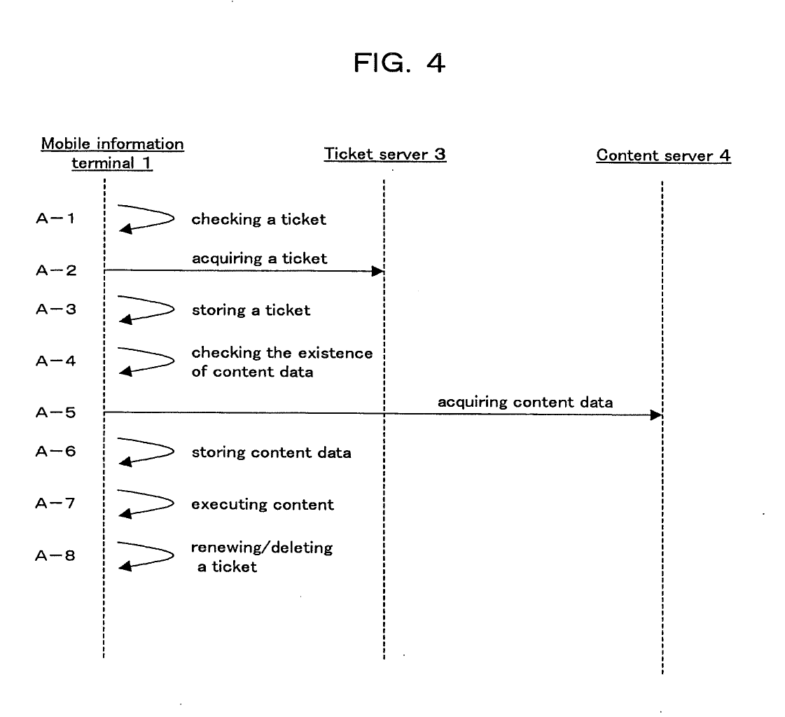

FIG. 4 is a sequence diagram of the operation explained below.

Step A-1: User needs a ticket to execute certain content so he/she operates the demand reception section 11 of the mobile information terminal 1. Then the mobile information terminal 1 checks to the ticket management section 13 whether an appropriate ticket exists in the storage section 16, and informs the user of the information through the demand reception section 11.

If the ticket exists, the process goes to step A-4.

Step A-2: If the ticket does not exist, the user demands a ticket at the demand reception section 11 and the information is transferred to the ticket management section 13. The ticket management section 13 communicates with the ticket server 3 through the communication section 14 and asks for an issuance of a ticket. In this case, the ticket management section 13 may ask the user a condition of the use of content through the demand reception section 11, then inform the ticket server 3 of the user's response and instruct the ticket server 3 to issue a ticket including the condition of the use of content. In this process the encoding/decoding section 17 establishes secure communications.

The ticket includes at least the following information:
(1) Content ID.
(2) Content server's address.
(3) Condition of the use of content (a limit for a frequency of use, a limit for accumulated time of use, etc.).
(4) Decoding key for content data (if the key is needed).

Step A-3: The ticket management section 13 stores the ticket in the storage section 16 and informs the demand reception section 11 of the existence of the ticket.

Step A-4: The user operates the demand reception section 11, selects the ticket and demands the execution of content. The demand reception section 11 sends the demand to the content management section 12.

The content management section 12 searches the storage section 16 for the content corresponding to a content ID in the ticket. If the requested content exists, the process goes to step A-7.

Step A-5: If the content does not exist, the content management section 12, through the communication section 14, communicates with the content server 4 that is identified by a content server address in the ticket, and obtains the content data corresponding to a content ID in the tickets.

Step A-6: The content management section 12 stores the content data in the storage section 16.

Step A-7: The player 15 is booted, taking in a condition of the use of content from the ticket. In this process a decoding key for the content data may be transferred together to the player 15.

The player 15, making sure that the condition of the use of content is valid, reads in the content data and executes it.

When the content data is encoded, the encoding/decoding section 17 delivers the decoded content data to the player 15. Or the player 15 may access to the encoding/decoding section 17 and then the content data is decoded. In this way the decoding process can be realized.

The encoding/decoding section 17 decodes the content data in the decoding process.

The content data is decoded based on the information of a decoding key alone. Alternatively, a decoding key may be generated from plural of key information, namely the information of a decoding key, the information of a key attached to content data and the information of a key in the mobile information terminal 1. In this case, validity of each of the information is checked, a decoding key is generated and then content data is decoded by that key.

At the first execution of the content corresponding to the ticket, the information of the ticket is linked with an identifier of a mobile information terminal, which uniquely identifies the mobile information terminal 1, and is stored in the storage section 16 with the identifier. Where a mobile information terminal is a cellular phone, a UIM (User Identity Module) card, which is an IC card used to identify subscribers, can be used as an identifier. Namely, any identifiers that identify a user are applicable.

At the next execution of the same content corresponding to the previously used ticket, the ticket is checked whether the identifier of a mobile information terminal liked with the ticket is that of the mobile information terminal 1 and then the content is executed.

In other words, content may be distributed and circulated in any way but in this system content cannot be replayed without a ticket. Further, by linking with a ticket an identifier for identifying the first mobile information terminal that played the content, this system restricts the way ticket is used.

The method of identifying the first mobile information terminal that has used content is not restricted to an identifier of a mobile information terminal but other methods can be applicable.

The player 15 stops when the demand reception section 11 receives from user an instruction to halt, or when user reaches the limit that the condition of the use of content defines.

Step A-8: When user reaches the limit defined by the condition of the use of content, the ticket becomes invalid. For example, where the condition of the use of content is that user can run the player 15 one hour, then the player 15 halts after one hour passes. Where the condition of the use of content defines that user can run the player 15 only once, the player 15 stops after the whole content is replayed.

User is informed of the end of replay through the demand reception section 11.

Where streaming data is supplied, user does not have to obtain and store content data. Thus the above-mentioned steps from step A-4 to step A-6 are skipped. A streaming type of content can be replayed by only booting the player 15 at step A-7.

Where the storage section 16 is a removable memory card, user can get tickets or content by inserting a removable memory card into a kiosk terminal that is able to function as the ticket server 3 and the content server 4. Here a kiosk terminal is an outfit that provides content like a video-game content, placed in a convenience store.

A ticket that has not ever been used can be a gift for other people. An identifier of a first mobile information terminal that plays the content is linked with a ticket so that a purchaser and a user of a ticket can be different person.

<(III) Use of Content at an External Device>

User may be able to access to an external device that has a high quality large screen or a high quality audio system around him/her (in his/her house, inside a store, etc.). The operation of a replay of content on the external device 2 is explained below.

If the mobile information terminal 1 in the scene (II) above does not have a ticket, the mobile information terminal 1 performs step A-1 in (II) and acquires a ticket.

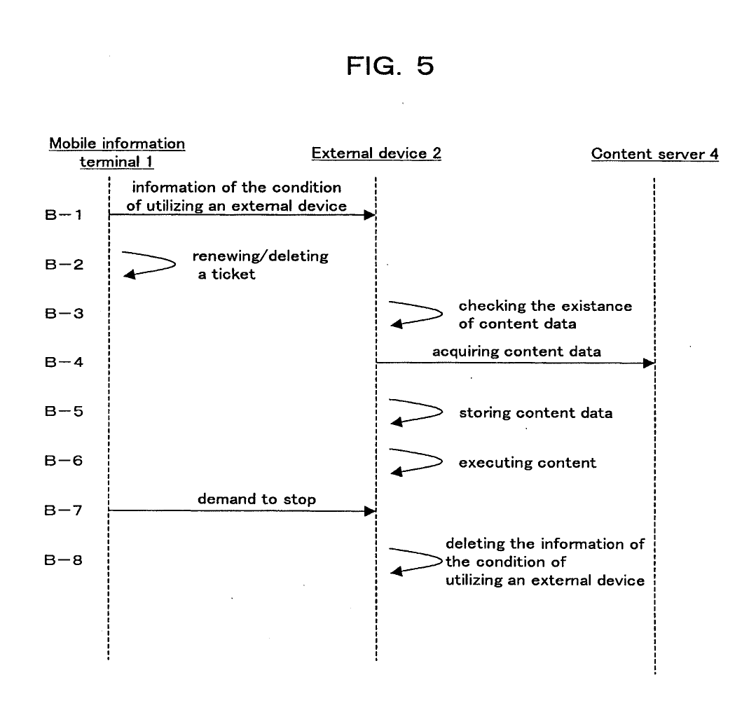

FIG. 5 is a sequence diagram of the operation of the system in which the mobile information terminal 1 possesses a ticket.

Step B-1: The mobile information terminal 1 informs the external device 2 that the mobile information terminal 1 has a right to use the external device 2, and requests the execution of content. The demand reception section 11 selects the ticket corresponding to the content that user wishes to replay on the external device 2, and informs it to the ticket management section 13. The ticket management section 13 takes out the ticket from the storage section 16 and informs the external device 2 through the communication section 14 of the information of the condition for utilizing the external device 2. The information includes the condition of the use of content. In this embodiment the condition of the use of content is that user can utilize the external device 2 only once.

Condition of the use of content is not restricted to the number of use but may be replaced with a period of time.

Communication is established between the communication sections 14 and 24 of the mobile information terminal 1 and the external device 2. The encoding/decoding sections 17 and 27 provide a secure channel.

If there are plural devices that work as the external device 2, user must designate one device.

In this embodiment the communication between the mobile information terminal 1 and the external device 2 is realized by an infrared remote control of directivity or a non-contact IC card. User holds the mobile information terminal 1 over the external device 2 so that the information of the condition for utilizing an external device is transferred and simultaneously one external device is chosen.

When the content corresponding to a ticket is executed for the first time, the information of the ticket stored in the storage section 16 is linked with an identifier that uniquely identifies the mobile information terminal 1 and is stored in the storage section 16 together with the identifier. Where a mobile information terminal being a cellular phone, a UIM card can be used as an identifier. Namely, any identifiers that identify a user are applicable.

At the next time to replay the content corresponding to the same ticket, an identifier liked with the ticket is checked whether it matches with the identifier of the mobile information terminal 1 and then the content is replayed.

The information of the condition for utilizing an external device in this step includes at least the following elements:

(1) Content ID.

(2) Content server address.

(3) Condition of the use of content.

(4) Decoding key for content data (if necessary).

(5) Key in a mobile information terminal (if necessary).

When the storage section 16 of the mobile information terminal 1 is a removable memory card, user may remove the memory card, which stores the above-mentioned information of the condition for utilizing an external device, from the mobile information terminal 1 and then insert it to the external device 2. In this way, the information of the condition for utilizing an external device is transferred to the external device 2.

Step B-2: After sending a demand for executing content to the external device 2, the mobile information terminal 1 terminates the communication with the external device 2 and rewrites the condition of the use of content in a ticket.

For example, when the condition of the use of content is defined as a book of five coupons, now the mobile information terminal 1 has demanded one execution to the external device 2, the mobile information terminal 1 decreases one coupon and this leaves four coupons. The ticket management section 13 rewrites the condition of the use of content in a ticket and stores it in the storage section 16.

Step B-3: The external device 2 receives the condition of utilizing an external device and then the demand reception section 21 delivers it to the ticket management section 23.

The ticket management section 23 does not store it into the storage section 26. The demand reception section 21 demands the execution of content to the content management section 22.

The content management section 22 searches the storage section 26 for the content data indicated by the content ID included in the condition of utilizing an external device. If the content data exist, the process goes to step B-6.

Step B-4: If the content data do not exist, the external device 2 obtains the content data from the mobile information terminal 1 or the content server 4.

When the external device 2 obtains the content data from the content server 4, the content management section 22 communicates through the communication section 24 with the content server 4, which is specified by a content server address included in the condition of utilizing an external device, and obtains the content data distinguished by a content ID included in the condition of utilizing an external device. At this process, the external device 2 may give to the content server 4 a request for a high quality replay. That request may either include or not include the property information of the external device like device's product name and device's name. If the content server 4 possesses the corresponding high quality content data, the high quality content data can be downloaded to the external device 2. Without a request for a high quality replay, the external device 2 obtains the content data of the same quality for the mobile information terminal 1.

In this way, content is replayed, matching with the performance of the external device 2.

When the external device 2 obtains the content data from the mobile information terminal 1, the content management section 22 inquires of the content management section 12 whether the content data exist, and if they exist, temporarily obtains the data. The data are deleted from the external device 2 after the replay of the content finishes.

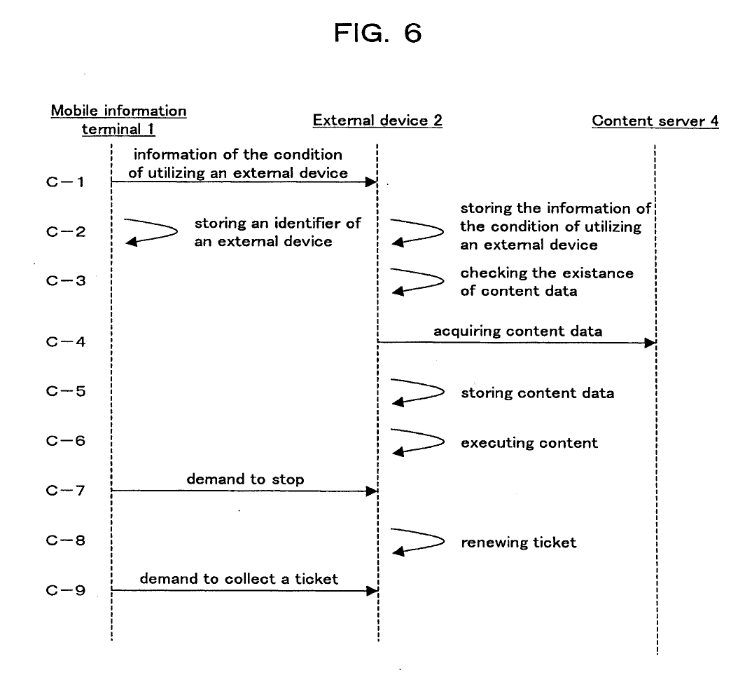

Between the above two ways, to obtain the data from a mobile information terminal or an external device, whichever way can be chosen (FIG. 6 does not show an arrow to indicate the acquisition of data from the mobile information terminal 1).

Step B-5: The content management section 22 stores the content data in the storage section 26.

Step B-6: The player 25 is booted, given the condition of the use of content. If required, the decoding key for the content data is also given to the player 25.

The player 25, confirming that the condition of the use of content is valid, reads in the content data and replays them.

In the case of dealing with the encoded content data, the encoding/decoding section 27 decodes the data and passes them to the player 25. The encoded content data may be accepted by the player 25. In this case the player 25 calls in the encoding/decoding section 27 and then the data is decoded.

The encoding/decoding section 27 decodes content data by the decoding key alone or generates a new decoding key from a decoding key for content data and a key attached to the content data. Each key is checked for its validity and then a new key is generated.

Step B-7: When user wishes to stop a replay running on the external device 2, a user issues the demand from the demand reception section 11. This demand is transferred to the ticket management section 13.

The ticket management section 13 gets an identifier of the mobile information terminal and sends it with a stop demand to the external device 2 through the communication section 14. The external device 2 receives and transfers them to the demand reception section 21.

To examine that a demand is sent from the mobile information terminal 1 that demanded the execution of content, the identifier is compared with the identifier of a mobile information terminal, which is included in the condition of utilizing an external device and stored in the storage section 26. After the demand is confirmed to have come from the same mobile information terminal, the demand reception section 21 orders the player 25 to stop.

The player 25 stops replaying the content. Even without a stop demand, the player stops when the condition of the use of content reaches the limit.

Step B-8: The ticket management section 23 deletes the condition of utilizing an external device, informed that the execution of content ended.

Dealing with streaming data, user does not have to get content data. As a result, the steps from B-3 to B-5 become unnecessary and streaming data is replayed by booting the player 25 at step B-6.

When the storage section 26 is a removable memory card, user can obtain content data, inserting the memory card into a kiosk terminal that functions as the content server 4.

When the storage section 16 in the mobile information terminal is also a removable memory card, the information of a user of an external device can be written into the memory card at the mobile information terminal 1. If the mobile information terminal 1 has content data, supposing the size of the content data is smaller than the capacity of the memory card, the information of a user of an external device and the content data can be carried together in the memory card to the external device 2.

<Effect of this Embodiment>

The first embodiment produces the following effect.

Firstly, a provider of content can protect rights like copyright.

This is because user cannot execute content on a mobile information terminal without a ticket. Further, content can be executed only on the same mobile information terminal that used the ticket for the first time and has the same identifier with that of a mobile information terminal in a ticket. Content also cannot be executed on an external device unless a mobile information terminal has a ticket.

Secondly, the same content that is originally expected to run on a mobile information terminal can be executed in higher sound and picture quality.

This is because an external device has a better performance than a mobile information terminal. In this embodiment user purchases by a mobile information terminal a right for enjoying content, transmits it to an external device and replays it on an external device. Comparing with a mobile information terminal, an external device can accept content data of higher quality.

Thirdly, user can select the most appropriate device for executing content in a given circumstance.

User always carries a mobile information terminal and under certain circumstances in which external devices exist, the user can transmit a ticket from a mobile information terminal to the desired external device.

Fourthly, user does not have to newly purchase a ticket for the use of an external device.

If a mobile information terminal possesses a ticket, then user only has to transmit it to an external device.

Fifthly, a content provider can disperse the load of servers.

This is because a ticket has a server address and from the server corresponding to the address, content data is downloaded.

Sixthly, any type of content player is applicable in this system.

This is because the content management sections 12 and 22 control the players 15 and 25 respectively.

Under a DRM (Digital Rights Management) system in a PC, a content player must have a component designed for DRM.

In this embodiment, however, the content management sections 12 and 22 can even control a player that does not work under a DRM system. So user selects a player according to the condition of the use of content. This means that various types of content player are applicable and a system can be built less expensively.

Seventhly, an external device refuses demands from a mobile information terminal without a ticket.

When the mobile information terminal sends a demand to an external device, it also sends an identifier of a mobile information terminal. In this way, an external device is controlled only by a mobile information terminal that possesses a ticket.

### Second Embodiment

This embodiment has the same structure as that of the first embodiment.

FIG. 6 is a sequence diagram of this embodiment. Steps different from the first embodiment are explained here.

Step C-1: In the first embodiment, the condition of utilizing an external device is a one-time execution. In this embodiment, the condition of utilizing an external device further includes an identifier for a mobile information terminal, which uniquely identifies a mobile information terminal.

This identifier, when a mobile information terminal is a cellular phone, may be a UIM card.

The aim of including the identifier is to identify the mobile information terminal that corresponds to the information in a ticket.

The external device 2 sends an identifier of an external device, which uniquely identifies an external device, to a mobile information terminal.

The condition of utilizing an external device includes at least the following information:
Identifier of a mobile information terminal
Ticket
Information of key in a mobile information terminal

The Identifier of an external device includes at least the following information:
ID for an external device
Information of location

Step C-2: The mobile information terminal 1 stores the identifier of an external device sent from the external device 2 in the storage section 16. The external device 2 stores the condition of utilizing an external device in the storage section 26.

The steps from C-3 to C-7 are the same with the steps from B-3 to B-7.

Step C-8: The condition of utilizing an external device is updated. For example, if a ticket is defined as a book of coupons, coupons are decreased according to the numbers of the execution of content.

Step C-9: User gets back a ticket. User orders it from the demand reception section 21. This demand is informed to the ticket management section 13 and an identifier of an external device is obtained from the storage section 16. The demand and the identifier are put together and sent to the external device 2 through the communication section 14. The external device 2 receives and transfers them to the demand reception section 21.

The demand reception section 21 takes out the ticket from the storage section 26 through the ticket management section 23 and sends the ticket to the mobile information terminal 1 through the communication section 24. The condition of utilizing an external device in the storage section 26 is deleted.

At this step, as step C-7, the identifiers of an external device and of a mobile information terminal are checked.

Receiving the ticket, the mobile information terminal stores it in the storage section 16. At this point the identifier of an external device is deleted.

If a ticket is not collected at step C-9, the content stays executable. Namely if the mobile information terminal 1 sends a replay instruction, the external device 2 can execute content. In this case the process go back to step C-3.

In the case of the execution of streaming data, steps for the acquisition of a ticket can be skipped. So the steps from C-3 to C-5 are unnecessary. The process jumps to step C-6 and streaming data are executed by booting the player 25.

If user forgets to retrieve the ticket from the external device 2, the identifier of an external device mentioned in step C-1 is displayed on the demand reception section 11. In this way, user knows where the ticket is. In addition, the location of the ticket can be displayed on a map to which the information of the location of an external device is linked.

A ticket is linked with an identifier of a mobile information terminal when the content corresponding to the ticket is executed for the first time. This process may be performed at step C-6 or C-9.

<Effect of this Embodiment>

The effect of the second embodiment is firstly that user can set the detailed conditions of the use of content on an external device.

In this embodiment, a ticket is moved from the mobile information terminal 1 to the external device 2. As a result the external device 2 can be controlled based on a ticket. Even if the ticket is defined as a time accumulation type, the accurate time of the execution of content is written on the ticket. Where the ticket is defined as a book of coupons, the communication between the mobile information terminal 1 and the external device 2 to reduce the numbers of coupons is omitted and the amount of communication data decreases.

Secondly, the external device does not operate by an instruction from a mobile information terminal without a ticket.

This is because an identifier of a mobile information terminal is sent together with the instruction to the external device 2. The external device 2 only executes the instruction issued from the same mobile information terminal that sends the ticket. Therefore, other mobile information terminals cannot control an external device even if the external device has a ticket in it.

Thirdly, user can specify an external device in which he or she has left a ticket.

This is because a mobile information terminal possesses an identifier of an external device. The identifier is sent from an external device when a mobile information terminal transmits a ticket to it.

Fourthly, the condition of the use of content directed to a mobile information terminal is also applicable to an external device.

This is because a ticket is sent from a mobile information terminal to an external device and the processes regarding to the ticket are performed on the external device.

### Third Embodiment

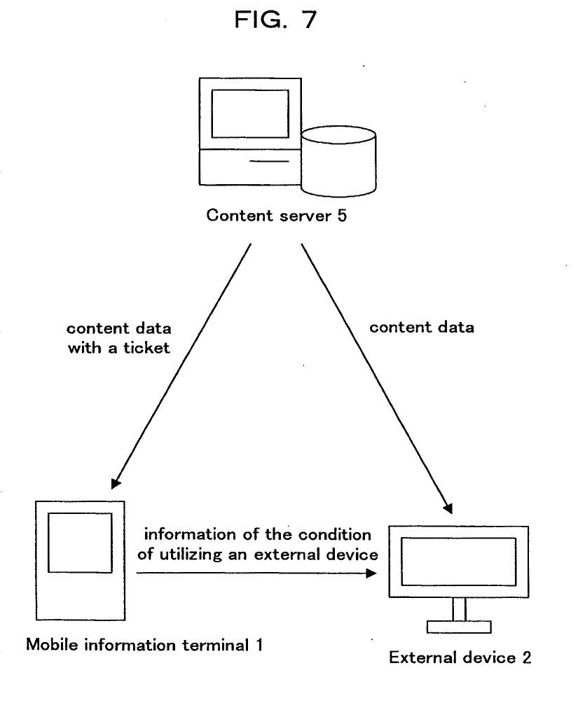

The system of this embodiment is shown on FIG. 7. The differences from FIG. 1 are that the ticket server 3 and the content server 4 are replaced with a content server 5.

The content server 5 manages both the content data with a ticket and the content data without a ticket.

The content data with a ticket is the data that can be executed on the mobile information terminal 1 and the amount of the data is comparatively small. The content data without a ticket are either the data similar to the content data with a ticket or the data for a higher quality replay. In the latter case, the amount of the data becomes larger. These two types of content data are executed by the ticket attached to the content data with a ticket.

The details of the mobile information terminal 1 and the external device 2 are same to that of the first embodiment, namely FIGS. 2 and 3.

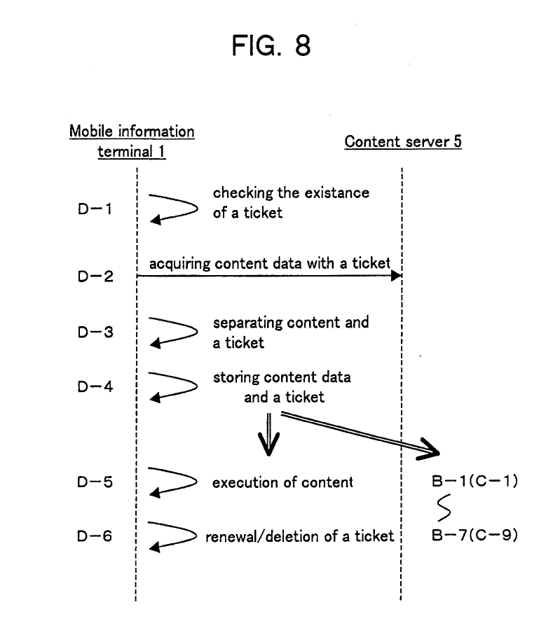

FIG. 8 is a sequence diagram of this embodiment. The explanation of process is given with FIG. 8.

Step D-1: User operates the demand reception section 11. The ticket management section 13 looks for the corresponding ticket in the storage section 16. The result is informed to the user through the demand reception section 11.

If the ticket exists, the process goes to step D-4.

Step D-2: If the ticket does not exist, the user demands the content data with a ticket and this demand is sent to the content management section 12.

The content management section 12 communicates with the content server 5 through the communication section 14 and obtains the content data with a ticket. The demand reception section 11 may let user input the condition of the use of content and send the information to the content server 5. Then the content server 5 issues the ticket containing the condition of the use of content. The encoding/decoding section 17 provides a secure communication channel by the encryption/decryption of data.

The ticket includes at least the following information:
Content ID
Content server address
Condition of the use of content (the numbers of use, the accumulated time of use, etc.)
Decoding key for content data (if necessary)

Step D-3: The mobile information terminal 1, acquiring the content data with a ticket, divides it into content data and a ticket.

Step D-4: The content management section 12 and the ticket management section 13 store the content data and the ticket separately in the storage section 16. At this point the content can be executed on an external device. Namely, the process selects the next step among the steps of D-5 (execution on a mobile information terminal), B-1 and C-1 (execution on an external device).

Step D-5 and D-6 are the same processes as that of steps A-7 and A-8.

When the content is executed on an external device, the process is similar to that of steps B-1˜B-7 or C-1˜C-9.

<Effect of this Embodiment>

The third embodiment reduces the amount of communication between a mobile information terminal and a content server.

This is because a mobile information terminal acquires content with a ticket.

### Fourth Embodiment

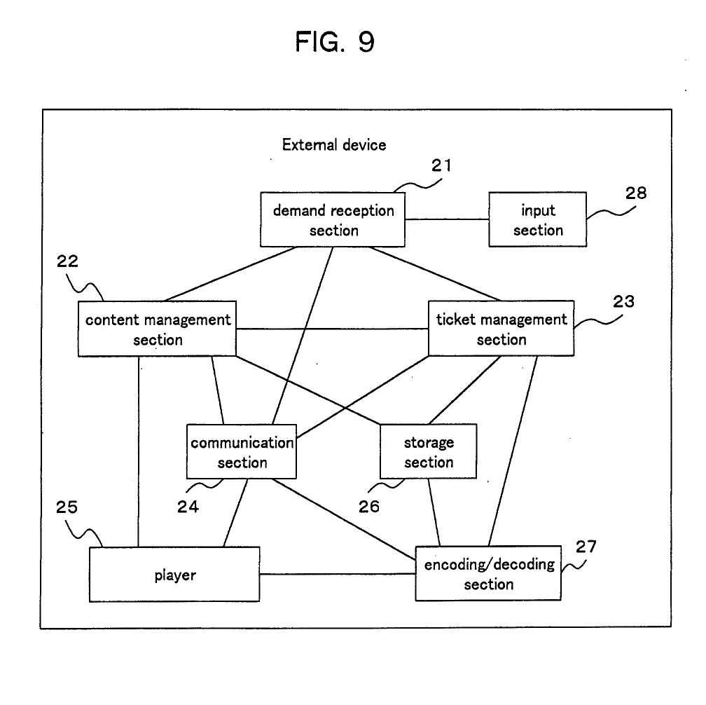

In this embodiment, as shown in FIG. 9, an input section 28 is newly added to the external device 2. The other elements are that of the first embodiment.

The demand reception section 21 handles the information inputted from the input section 28 and this enables user to input commands directly into the external device 2.

The processes of this embodiment are explained below.

A sequence diagram for this embodiment is that of the first˜third embodiment, except that steps 7 of each embodiment are replaced with the following step E-7.

Step E-7: When user wishes to stop the external device 2, the user directly inputs the command into the external device by operating buttons, a GUI (Graphical User Interface) or by a speech input.

The authentication of an identifier of the mobile information terminal 1 is cancelled at this process.

The demand reception section 21 orders the player 25 to stop through the content management section 22. Receiving the command, the player 25 stops. An input of an execution command is also realized by the same way.

<Effect of this Embodiment>

This embodiment presents an easy operation of the system because user only has to operate an external device to execute content in it. Namely, except the transmission and reception of a ticket, user directly operates an external device.

A mobile information terminal establishes communication of some directivity or of short range. In this case the mobile information terminal may need to be fixed in some angle or distance. Direct inputs into an external device cancel this troublesome process.

### Fifth Embodiment

In this embodiment, the system is applied to a local area network like a network in a store.

The number of channels and the amount of data running through them are different from the other embodiments.

The system of this embodiment is the same as that of the first embodiment.

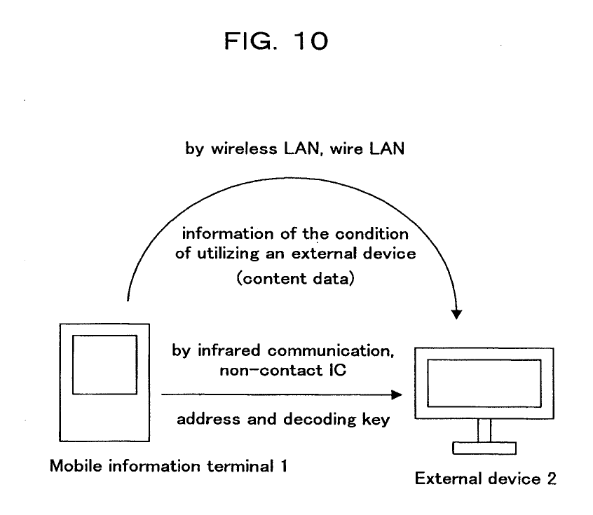

In this embodiment the process of steps 1 in the 1^{st}-3^{rd} embodiments are replaced with step F-1. This embodiment is explained referring to FIG. 10.

Step F-1: The external device 2 is designated.

The mobile information terminal 1 sends its address to the external device 2 through the communication section 14. The external device 2 sends its address to the mobile information terminal 1 through the communication section 24. At the same time an encoding key may be transferred to establish secure communication.

This communication is of some directivity like an infrared communication, a non-contact IC communication, the reading of a bar code in a display etc., or of short range or both. To designate an external device, the mobile information terminal 1 is held over the external device 2 or is connected to it by a cable like USB (Universal Serial Bus).

Then the mobile information terminal 1 selects a ticket and informs it to the ticket management section 13. The ticket management section 13 picks up the ticket from the storage section 16 and through the communication section 14 sends the condition of utilizing an external device, which includes the condition of the use of content. This communication is of non-directivity, using wireless LAN, Bluetooth, or wire LAN.

The communication is established between the communication sections 14 and 24. The encoding/decoding section 17 and 27 provides a secure channel. As an encoding key, the key acquired with the address is used.

In all the steps hereinafter, the communication is of non-directivity.

In this embodiment, the external device 2 checks whether user exists in neighborhood during the execution of content. This function is set at an initial setting.

The above function having been set, the external device 2, during the execution of content, sends a signal at a fixed pace to the mobile information terminal 1 to check the existence of a user. The mobile information terminal 1 is specified by the address gotten in step F-1. If the mobile information terminal does not respond to the signal, the external device 2 stops the execution of content.

The signal may be transmitted from an external device or a mobile information terminal or both—the device and the terminal may communicate interactively.

<Effect of this Embodiment>

By this embodiment, it is no more necessary to think of the location of an external device and the directions of an external device and a mobile information terminal.

Both a mobile information terminal and an external device know each other's address and the communication of non-directivity is established between them. So user can input the command for an external device in a free style, facing free directions. Only once user has to hold a mobile information terminal over an external device when the addresses are exchanged.

Secondly, when the mobile information terminal is out of a local area network, the external device stops the execution of content.

This is because the mobile information terminal and the external device contact each other in a certain period and when the communication ends, the external device concludes that the mobile information terminal is no more nearby.

### Sixth Embodiment

This embodiment realizes an acquisition of content data based on a Peer to Peer system.

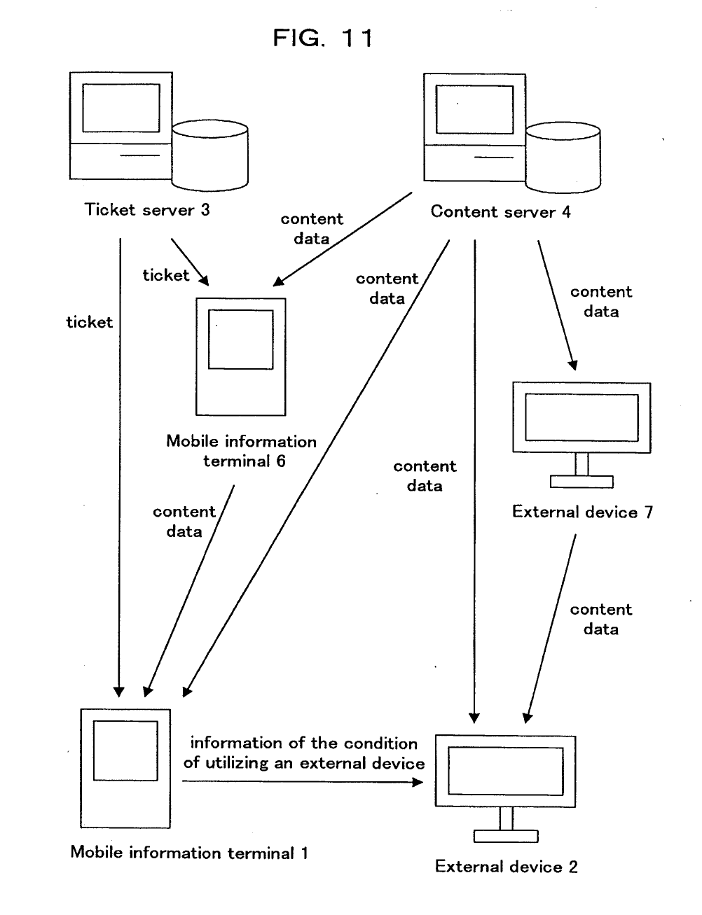

FIG. 11 shows the system of this embodiment.

The difference from FIG. 1 is that a mobile information terminal 6 and an external device 7 are newly added.

The mobile information terminal 6 has the same construction with the mobile information terminal 1 (FIG. 2). The external device 7 also has the same construction with the external device 2 (FIG. 3).

However, the content management sections 12 in the mobile information terminals 1 and 6 have a content data discovery function in this embodiment. The content management sections 22 in the external devices 2 and 7 also have a content data discovery function. The content discovery function is a function that looks for the requested content data.

In this embodiment, the way to obtain content data is different from those of the previous embodiments. Only the different processes (hereinafter called step G-5 and step H-4) are explained below.

User handles both the mobile information terminal 1 and the external device 2.

Step G-5: In step A-5, the mobile information terminal 1 obtains content data from the content server 4. In this step, however, the mobile information terminal 1 searches other mobile information terminals for the content data, using the content data discovery function. The search is implemented with a content ID. If the mobile information terminal 6 has the content data, the data is transferred to the mobile information terminal 1. If the content data are not found, the data are obtained from the content server 4.

Step H-4: In step B-4, the external device 2 obtains content data from the content server 4. In this step, however, the external device 2 searches other external devices for the content data, using the content data discovery function. The search is executed with a content ID. If the external device 7 has the content data, the data are transferred to the external device 2. If the data are not found, the content data are downloaded from the content server 4 as the first embodiment.

These searches are realized by the same method as a P2P system, in which personal computers communicate directly with each other.

<Effect of this Embodiment>

This embodiment distributes the load of the content server 4.

If the requested content data exists in other mobile information terminals or external devices, a mobile information terminal or an external device puts a higher priority on that content data. Namely, the content data can be obtained without the communication between the mobile information terminal and the content server 4.

### EFFECT OF THIS INVENTION

As set forth hereinbefore, according to the present invention, only a mobile information terminal with a ticket can execute content data on an external device. In this way copyright is protected.

Further, content data is selected matching with the performance of an external device so that the content data is replayed in a higher sound and picture quality.

<Other Description>

As described above, according to a first aspect of the present invention, there is provided a system for executing content, comprising a mobile information terminal, an external device, a ticket server and a content server, in which the mobile information terminal comprises means for acquiring a ticket from said ticket server, means for storing the ticket, means for demanding an execution of content to the external device, means for demanding halt of content to the external device, means for renewing condition of the use of content. The external device comprises means for receiving a demand from the mobile information terminal, means for acquiring content data, means for executing content, means for halting execution of content, the ticket server comprises means for storing tickets corresponding to content, means for receiving a content ID from the content server. The content server comprises means for storing content data designed to match with the performance of the external device.

According to a second aspect of the present invention, in the system in the first aspect, the external device further comprises means for checking the existence of the mobile information terminal periodically.

According to a third aspect of the present invention, in the system in the first aspect, the mobile information terminal further comprises means for designating an external device, means for transferring condition of the use of content, and means for deciding which mobile information terminal has used content.

According to a fourth aspect of the present invention, in the system in the third aspect, the mobile information terminal links an identifier to a ticket, stores the ticket and provides the ticket at the next time of the execution of content.

According to a fifth aspect of the present invention, in the system in the first aspect, the external device further comprises means for acquiring content from the mobile information terminal and storing the content.

According to a sixth aspect of the present invention, in the system in the first aspect, the external device further comprises means for acquiring content from the content server and storing the content.

According to a seventh aspect of the present invention, in the system in the first aspect, the external device further comprises means for receiving command inputs.

According to an eighth aspect of the present invention, in the system in the first aspect, the external device terminates execution of content, receiving a demand from the mobile information terminal.

According to a ninth aspect of the present invention, in the system in the first aspect, the external device terminates the execution of content according to condition of the use of content.

According to a tenth aspect of the present invention, in the system in the first aspect, the external device terminates execution of content, receiving command inputs.

According to an eleventh aspect of the present invention, there is provided a mobile information terminal comprising means for acquiring a ticket from a ticket server, means for storing the ticket, means for acquiring content from a content server, means for storing the content, means for executing the content, means for renewing the ticket, means for sending demand for executing content to an external device, and means for sending demand for terminating the execution of content to the external device.

According to a twelfth aspect of the present invention, in the eleventh aspect, the mobile information terminal further comprises means for qualifying itself to be the terminal that used content.

According to a thirteenth aspect of the present invention, in the twelfth aspect, the mobile information terminal further comprises means for linking an identifier to a ticket, storing the ticket and providing the ticket at the next time of execution of content.

According to a fourteenth aspect of the present invention, there is provided an external device comprising means for communicating with a mobile information terminal, means for receiving command inputs, means for acquiring content, means for executing content, and means for checking the existence of a mobile information terminal in neighborhood.

According to a fifteenth aspect of the present invention, in a fourteenth aspect, the external device further comprises means for acquiring content data corresponding to the performance of the external device.

According to a sixteenth aspect of the present invention, there is provided a method for a mobile information terminal to execute content, comprising the steps of acquiring a ticket, storing the ticket, acquiring content, executing the content, and renewing or abandoning the ticket.

According to a seventeenth aspect of the present invention, in the sixteenth aspect, the mobile information terminal acquires content from a content server or other mobile information terminals.

According to an eighteenth aspect of the present invention, in the sixteenth aspect, the mobile information terminal stores content.

According to a nineteenth aspect of the present invention, in the sixteenth aspect, the method further comprises the step of deciding which mobile information terminal has used content.

According to a twentieth aspect of the present invention, in the nineteenth aspect, the mobile information terminal links an identifier to a ticket, stores the ticket and provides the ticket at the next time of execution of content.

According to a twenty-first aspect of the present invention, there is provided a method for a mobile information terminal to execute content, comprising the steps of acquiring a ticket from a ticket server, storing the ticket, demanding execution of content to an external device, renewing or abandoning the ticket and demanding termination of the execution of content to the external device.

According to a twenty-second aspect of the present invention, in the twenty-first aspect, the method further comprises the step of designating an external device before the execution of content.

According to a twenty-third aspect of the present invention, in the twenty-second aspect, the method further comprises the step of checking the existence of the mobile information terminal that has designated an external device.

According to a twenty-fourth aspect of the present invention, in the twenty-first aspect, the method further comprises the steps of selecting a ticket, taking out condition of the use of content included in the ticket, and sending the condition of the use of content to an external device before execution of content.

According to a twenty-fifth aspect of the present invention, there is provided a method for an external device to execute content comprises the steps of receiving condition of the use of content from a mobile external device, acquiring content from a content server, executing content, terminating execution of content and deleting the condition of the use of content.

According to a twenty-sixth aspect of the present invention, in the twenty-fifth aspect, the method further comprises the step of storing content before executing content.

According to a twenty-seventh aspect of the present invention, in the twenty-fifth aspect, the method further comprises the step of recognizing a mobile information terminal that has sent condition of the use of content.

According to a twenty-eighth aspect of the present invention, in the twenty-seventh aspect, the method further comprises the step of linking an identifier for a mobile information terminal with a ticket, storing said identifier and said ticket.

According to a twenty-ninth aspect of the present invention, in the twenty-fifth aspect, the method further comprises the step of receiving command inputs.

According to a thirtieth aspect of the present invention, in the twenty-fifth aspect, the method further comprises the step of searching other external devices for content.

According to a thirty-first aspect of the present invention, there is provided a method of executing content, comprising the steps of exchanging identifiers between a mobile information terminal and an external device, the external device's acquiring content from a content server, executing content, terminating execution of content, renewing a ticket and the mobile information terminal's collecting the ticket from the external device.

According to a thirty-second aspect of the present invention, in the method in the thirty-first aspect, at the exchange of identifiers the mobile information terminal sends a ticket and condition of the use of content including an identifier of the mobile information terminal to the external device, the external device sends an identifier of the external device to the mobile information terminal and the mobile information terminal and the external device store the information of said identifier.

According to a thirty-third aspect of the present invention, in the thirty-first aspect, the mobile information terminal designates an external device before the exchange of identifiers.

According to a thirty-fourth aspect of the present invention, in the thirty-third aspect, the method further comprises the step of checking the existence of the mobile information terminal in neighborhood.

According to a thirty-fifth aspect of the present invention, in the thirty-first aspect, the method further comprises the step of storing content before executing said content.

According to a thirty-sixth aspect of the present invention, in the thirty-first aspect, the external device receives command inputs to terminate the execution of content.

According to a thirty-seventh aspect of the present invention, in the thirty-first aspect, the external device searches other external devices for content.

According to a thirty-eighth aspect of the present invention, in the thirty-first aspect, the mobile information terminal stores an identifier of the mobile information terminal linked with a ticket.

According to a thirty-ninth aspect of the present invention, there is provided a method for a mobile information terminal to execute content, comprising the steps of acquiring content with a ticket from a content server, separating the content and the ticket apart, storing the content and the ticket separately, executing the content and renewing or deleting the ticket.

According to a fortieth aspect of the present invention, there is provided a program for an external device to execute content, performing the processes of receiving condition of the use of content, including a content ID, from a mobile information terminal, receiving a demand to execute content from the mobile information terminal, obtaining content, executing content, receiving a demand to terminate the execution of content, terminating the execution of content and deleting the condition of the use of content from a storage section.

According to a forty-first aspect of the present invention, in the fortieth aspect, the program further performs the process of periodically checking the existence of the mobile information terminal in neighborhood.

According to a forty-second aspect of the present invention, in the fortieth aspect, the program further performs the process of searching other external devices for the requested content.

According to a forty-third aspect of the present invention, in the fortieth aspect, the program further performs the processes of obtaining content from the mobile information terminal and storing the content in a storage section.

According to a forty-fourth aspect of the present invention, in the fortieth aspect, the program further performs the processes of obtaining content from a content server and storing the content in a storage section.

According to a forty-fifth aspect of the present invention, in the forty-fourth aspect, the program further performs the processes of referring to a content server address and communicating with a content server, referring to the content ID and obtaining content.

According to a forty-sixth aspect of the present invention, in the forty-fifth aspect, the program further performs the process of selecting content matching with the performance of a hardware on which the content is executed.

According to a forty-seventh aspect of the present invention, in the fortieth aspect, the program further performs the processes of storing an identifier of a mobile information terminal linked with a ticket, decoding content, confirming the validity of condition of the use of content and booting a content player.

According to a forty-eighth aspect of the present invention, in the fortieth aspect, the program further performs the processes of receiving a demand from the mobile information terminal and stopping a content player.

According to a forty-ninth aspect of the present invention, in the fortieth aspect, the program further performs the processes of confirming that the condition of the use of content is fulfilled and stopping a content player.

According to a fiftieth aspect of the present invention, there is provided a program for an external device to execute content, performing the processes of sending an identifier of the external device to a mobile information terminal, receiving a ticket and condition of the use of content including an identifier of the mobile information terminal, storing the condition of the use of content in a memory, acquiring content from a content server, executing content, terminating the execution of content and renewing the ticket.

According to a fifty-first aspect of the present invention, in the fiftieth aspect, the program further performs the process of checking in neighborhood the existence of the mobile information terminal identified by the identifier.

According to a fifty-second aspect of the present invention, in the fiftieth aspect, the program further performs the process of storing content data in a memory.

According to a fifty-third aspect of the present invention, in the fiftieth aspect, the program further performs the process of storing the identifier linked with the ticket in a memory.

According to a fifty-fourth aspect of the present invention, in the fiftieth aspect, the program further performs the process of receiving command inputs.

According to a fifty-fifth aspect of the present invention, in the fiftieth aspect, the program further performs the process of searching other external devices for the requested content.

According to a fifty-sixth aspect of the present invention, there is provided a program for a mobile information terminal to execute content, performing the processes of receiving input of information of a ticket, searching a storage section for the ticket, acquiring a ticket with condition of the use of content from a content server, storing the ticket in a storage section, receiving input of a demand to execute content, acquiring content, executing content and terminating the execution of content.

According to a fifty-seventh aspect of the present invention, in the fifty-sixth aspect, the program further performs the processes of referring to a content server address and communicating with a content server, referring to a content ID included in the ticket and downloading the corresponding content and storing the content in a storage section.

According to a fifty-eighth aspect of the present invention, in the fifty-sixth aspect, the program further performs the process of searching other mobile information terminal for the requested content.

According to a fifty-ninth aspect of the present invention, in the fifty-sixth aspect, the program further performs the processes of linking an identifier of the mobile information terminal and the ticket, storing the identifier and the ticket in a storage section, decoding content data, confirming the validity of the condition of the use of content and booting a content player.

According to a sixtieth aspect of the present invention, in the fifty-sixth aspect, the program further performs the processes of receiving a demand to halt from the mobile information terminal and stopping a content player.

According to a sixty-first aspect of the present invention, in the fifty-sixth aspect, the program further performs the processes of confirming that the condition of the use of content is fulfilled and terminating a content player.

According to a sixty-second aspect of the present invention, there is provided a program for a mobile information terminal to execute content, performing the processes of receiving input of the information of a ticket, checking the existence of the ticket in a storage section, sending back the result, acquiring the ticket with condition of the use of content from a content server, storing the ticket in a storage section, specifying an external device to execute content, transmitting condition of utilizing an external device including a content ID to an external device, receiving input of an execution demand, demanding execution of content to the external device and renewing the condition of utilizing external device.

According to a sixty-third aspect of the present invention, there is provided a program for a mobile information terminal to execute content, performing the processes of receiving input of the information of a ticket, checking the existence of the ticket in a storage section, sending back the result, acquiring the ticket with condition of the use of content from a ticket server, storing the ticket in a storage section, transmitting the ticket and an identifier of the mobile information terminal to an external device, receiving an identifier of an external device from the external device, storing the identifier in a storage section, demanding the execution of content to the external device and collecting the ticket from the external device after the execution of content.

According to a sixty-fourth aspect of the present invention, in the sixty-third aspect, the program further performs the process of designating an external device to execute content.

According to a sixty-fifth aspect of the present invention, there is provided a program for a mobile information terminal to execute content performing the processes of checking the existence of a ticket in a storage section, acquiring content with a ticket from a content server, separating the content and the ticket, storing the content and the ticket separately in a storage section, executing the content and renewing or deleting the ticket.

According to a sixty-sixth aspect of the present invention, in the sixty-fifth aspect, the program further performs the process of storing an identifier of a mobile information terminal linked with the ticket in a storage section.

What is claimed is:

1. A mobile information terminal for executing content, comprising:
means for acquiring a ticket from a ticket server;
means for storing said ticket;
means for acquiring content from a content server;
means for storing said content;
means for executing said content;
means for renewing said ticket;
means for sending demand for executing content to an external device; and
means for sending demand for terminating the execution of content to said external device.

2. The mobile information terminal as claimed in claim 1 further comprising means for qualifying itself to be the terminal that used content.

3. The mobile information terminal as claimed in claim 2 further comprising means for linking an identifier to a ticket, storing said ticket and providing said ticket at the next time of execution of content.

4. A method for a mobile information terminal to execute content comprising the steps of:
acquiring a ticket;
storing said ticket;
acquiring content;
executing said content; and
renewing or abandoning said ticket.

5. The method as claimed in claim 4 wherein said mobile information terminal acquires content from a content server or other mobile information terminals.

6. The method as claimed in claim 4 wherein said mobile information terminal stores content.

7. The method as claimed in claim 4 further comprising the step of deciding which mobile information terminal has used content before executing content.

8. The method as claimed in claim 7 wherein said mobile information terminal links an identifier to a ticket, stores said ticket and provides said ticket at the next time of execution of content.

9. A method for a mobile information terminal to execute content, comprising the steps of:
acquiring a ticket from a ticket server;
storing said ticket;
demanding execution of content to an external device;
renewing or abandoning said ticket; and
demanding termination of the execution of content to said external device.

10. The method as claimed in claim 9 further comprising the step of designating an external device before the execution of content.

11. The method as claimed in claim 10 further comprising the step of checking the existence of the mobile information terminal that has designated an external device.

12. The method as claimed in claim 9 further comprising the steps of:
selecting a ticket;
taking out condition of the use of content included in said ticket; and
sending said condition of the use of content to an external device before execution of content.

13. A method for a mobile information terminal to execute content, comprising the steps of:
acquiring content with a ticket from a content server;
separating said content and said ticket apart;
storing said content and said ticket separately;
executing said content; and
renewing or deleting said ticket.

14. A program for a mobile information terminal to execute content performing the processes of:
receiving input of information of a ticket;
searching a storage section for said ticket;
acquiring a ticket with condition of the use of content from a content server;
storing said ticket in a storage section;
receiving input of a demand to execute content;
acquiring content;
executing content; and
terminating the execution of content.

15. The program as claimed in claim 14 further performing the processes of:
referring to a content server address and communicating with a content server;
referring to a content ID included in said ticket and downloading the corresponding content; and
storing said content in a storage section.

16. The program as claimed in claim 14 further performing the process of searching other mobile information terminal for the requested content.

17. The program as claimed in claim 14 further performing the processes of:
linking an identifier of said mobile information terminal and said ticket;
storing said identifier and said ticket in a storage section;
decoding content data;
confirming the validity of said condition of the use of content; and
booting a content player.

18. The program as claimed in claim 14 further performing the processes of:
receiving a demand to halt from said mobile information terminal; and
stopping a content player.

19. The program as claimed in claim 14 further performing the processes of:
confirming that said condition of the use of content is fulfilled; and
terminating a content player.

20. A program for a mobile information terminal to execute content, performing the processes of:
receiving input of the information of a ticket;
checking the existence of said ticket in a storage section;
sending back the result;
acquiring said ticket with condition of the use of content from a content server;
storing said ticket in a storage section;
specifying an external device to execute content;
transmitting condition of utilizing an external device including a content ID to an external device;
receiving input of an execution demand;
demanding execution of content to said external device; and
renewing said condition of utilizing external device.

21. A program for a mobile information terminal to execute content, performing the processes of:
receiving input of the information of a ticket;
checking the existence of said ticket in a storage section;
sending back the result;
acquiring said ticket with condition of the use of content from a ticket server;
storing said ticket in a storage section;
transmitting said ticket and an identifier of said mobile information terminal to an external device;
receiving an identifier of an external device from said external device;
storing said identifier in a storage section;
demanding the execution of content to said external device; and
collecting said ticket from said external device after the execution of content.

22. The program as claimed in claim 21 further performing the process of designating an external device to execute content.

23. A program for a mobile information terminal to execute content performing the processes of:
checking the existence of a ticket in a storage section;
acquiring content with a ticket from a content server;
separating said content and said ticket;
storing said content and said ticket separately in a storage section;
executing said content; and
renewing or deleting said ticket.

24. The program as claimed in claim 23 further performing the process of storing an identifier of a mobile information terminal linked with said ticket in a storage section.
